(19) United States
(12) Patent Application Publication
(10) Pub. No.: US 2025/0388053 A1
(43) Pub. Date: Dec. 25, 2025

(54) Tire Deflation System and Method For Automotive Service Equipment

(71) Applicant: Hunter Engineering Company, Bridgeton, MO (US)

(72) Inventors: Joel Clasquin, Highland, IL (US); James Hudson, St. Louis, MO (US)

(21) Appl. No.: 19/245,841

(22) Filed: Jun. 23, 2025

Related U.S. Application Data
(60) Provisional application No. 63/664,154, filed on Jun. 25, 2024.

(51) Int. Cl. B60C 25/05

(52) U.S. Cl. CPC B60C 25/0515; B60C 25/0506; B60C 25/0512; B60C 25/0518; B60C 25/0548

(57) ABSTRACT

A vehicle wheel service system with a control system and air pathway coupling an inflated tire to an air discharge into a low pressure volume for accelerated deflation of the tire, and for reducing tire inflation pressure below atmospheric pressure during a tire demount procedure.

### CROSS-REFERENCE TO RELATED APPLICATIONS

The present application is related to, and claims priority from, co-pending US provisional patent application Ser. No. 63/664,154 filed on Jun. 25, 2024 and which is herein incorporated by reference.

### STATEMENT REGARDING FEDERALLY SPONSORED RESEARCH

Not Applicable.

### BACKGROUND OF THE INVENTION

The present application is related generally to automotive service equipment intended for tire mounting, tire demounting, and imbalance correction in tires, and in particular, to a system and method for facilitating controlled deflation of a tire prior to separating the tire from a rim on which it is mounted.

Many products manufactured for the automotive service industry are designed to assist an operator by inflating automotive tires. These systems generally provide a source of pressurized air via an air hose and an air chuck to inflate the tire when it is mounted to a rim of a wheel assembly. The operator manually connects the air chuck at the end of the air hose to a valve stem of the wheel assembly and initiates a flow of pressurized air from the source through the air hose and air chuck. The resulting airflow into the volume enclosed by the tire and wheel rim is either monitored by the operator via a pressure gauge, or is automatically terminated upon reaching a set inflation pressure point.

During a tire changing or tire replacement procedure, a tire is removed from the wheel rim on which it is mounted. This procedure begins by removing a core from the wheel assembly valve stem, allowing any pressurized air within the tire to escape to atmosphere. Ideally, the tire should be fully deflated before removal from the wheel rim, however the larger tire sizes common on many of the newer model vehicles can take a significant amount of time to fully deflate through the constricted opening created by the valve stem. Tire service technicians will often grow impatient waiting for the tire to deflate and begin the tire demounting procedure while the tire still retains a significant amount of pressurized air. Using powered tire changing tools, such as found on many tire changing machines, a partially inflated tire can be forcefully demounted from a wheel rim, however, doing so places undue stress on the equipment, and can result in premature equipment wear and/or damage in the form of bent or broken components.

Accordingly, it would be beneficial to configure tire changing automotive service equipment to enable accelerated and controlled deflation of a tire mounted on a wheel rim, followed by automated removal of the tire from the wheel rim with minimal operator interaction, enabling operator walk-away operation.

### BRIEF SUMMARY OF THE INVENTION

Briefly stated, the present disclosure provides a vehicle wheel service system or wheel service workstation with an air pathway and control system for accelerated deflation of a pressurized tire during to a tire demount procedure.

In one embodiment, a flexible length of retractable air hose couples an air discharge port into a volume maintained below atmospheric pressure to an air chuck operatively configured for temporary air-tight engagement with a valve stem of a wheel assembly. The wheel assembly may be supported on a rotationally driven spindle of the vehicle tire changing system or wheel balancer, contained within a tire inflation cage, or even free-standing within an automotive service workspace. The air discharge port, air hose, and air chuck enable a transfer of pressurized air from an inflated tire to the low pressure volume during a wheel service procedure.

In a first configuration, the volume is an air storage tank which is at least partially evacuated by means of a vacuum pump as needed to maintain an internal pressure level below atmospheric pressure.

In a further configuration, the air discharge port and volume are defined by a venturi having an orifice across which a flow of compressed air is passed to reduce pressure at the air discharge below atmospheric pressure.

In another embodiment, the air chuck is coupled to the air hose by a swivel connection, and the air hose extends from a support housing axially above the wheel assembly. The swivel connection and axial position of the air hose enables the air chuck to be connected to the valve stem of a wheel assembly mounted while the wheel assembly is rotated, enabling tire demount tools to apply force to the tire sidewalls and unseat the tire beads as the tire inflation pressure decreases.

In a further embodiment, the air chuck is configured with an automatic release mechanism, enabling a control system for the tire changing system to release the air chuck from the tire inflation valve during the tire demount procedure. The released air chuck is then withdrawn away from the wheel assembly by retraction of the air hose, avoiding interference with tire removal and/or installation of a replacement tire.

A method of the present disclosure enables efficient operation of a vehicle tire changing system during tire deflation and demounting procedures. Initially, a wheel assembly consisting of a rim and inflated tire is secured to a spindle of the vehicle tire changing system. A core is removed from the inflation valve of the wheel assembly, and an air chuck located at an end of a flexible length of air hose is drawn from a stored position and secured in air-tight engagement with the opened valve stem. Pressurized air is transferred from the inflated tire through the opened valve stem and air chuck and delivered to an air discharge via the air hose. Pressure at the air discharge is maintained below atmospheric pressure, creating a pressure gradient between the inflated tire and air discharge, increasing the rate of tire deflation. Once the tire has deflated below a selected threshold, forces are applied to the tire sidewall surfaces via one or more demount tools of the tire changing system, separating the tire beads from the rim bead seat surfaces. Prior to complete removal of the deflated tire from the rim, the air chuck is released from the valve stem, and the air hose retracted away from the wheel assembly.

In a variation of the method of the present disclosure, the inflation pressure of the tire is monitored during the application of forces to the tire sidewall surfaces via the one or more demounting tools. Detection of a sudden change in inflation pressure is indicative of a separation of the tire bead from the rim bead seat surface or movement of the tire bead past a wheel rim safety hump. Responsive to the detected change, the operation of the tire changing system may be altered to account for the change in tire condition, such as by a reduction in force applied to the tire sidewall surface, or an increase in a rotational speed of the wheel assembly.

The foregoing features, and advantages set forth in the present disclosure as well as presently preferred embodiments will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is front perspective view of a tire changing system configured with an air inflation system of the present disclosure;

FIG. 2 is a cross sectional view of the air chuck and air hose of the air inflation system of FIG. 1, in a retracted position;

FIG. 3 is a flow chart illustrating a method of the present disclosure; and

FIG. 4 is a flow chart illustrating a variation to the method of FIG. 3.

Corresponding reference numerals indicate corresponding parts throughout the several figures of the drawings. It is to be understood that the drawings are for illustrating the concepts set forth in the present disclosure and are not to scale.

Before any embodiments of the invention are explained in detail, it is to be understood that the invention is not limited in its application to the details of construction and the arrangement of components set forth in the following description or illustrated in the drawings.

### DETAILED DESCRIPTION

The following detailed description illustrates the invention by way of example and not by way of limitation. The description enables one skilled in the art to make and use the present disclosure, and describes several embodiments, adaptations, variations, alternatives, and uses of the present disclosure, including what is presently believed to be the best mode of carrying out the present disclosure.

The present invention is described and show as incorporated into a tire changing system, but those of ordinary skill in the art will readily appreciate that the tire deflation system of the present disclosure can be incorporated into a wide range of vehicle wheel service equipment and workstations without departing from the scope of the invention.

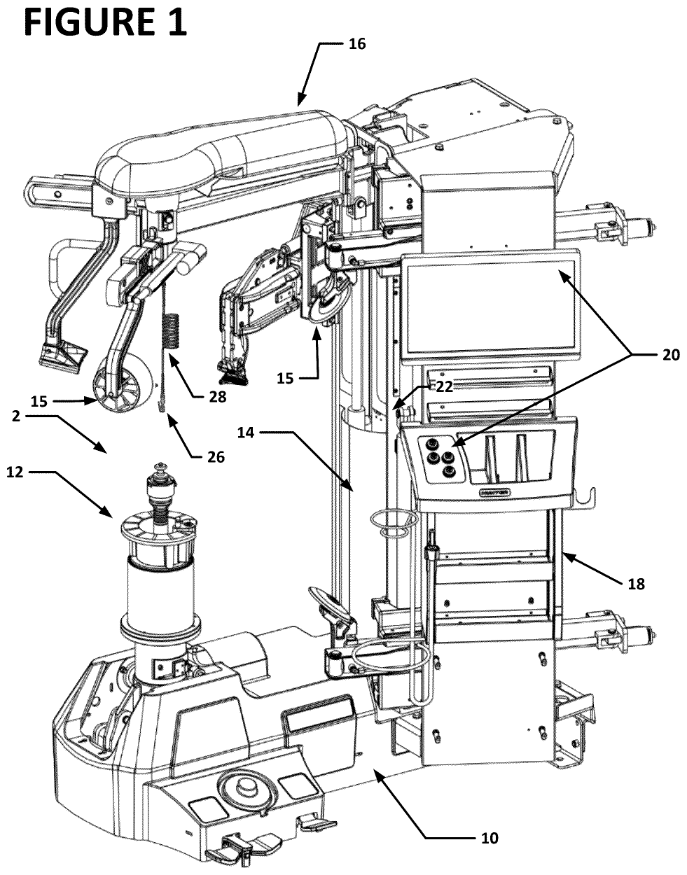

As seen in FIG. 1, an exemplary tire changing system 2 includes a base structure 10 for supporting various components. The base structure 10 provides support for a rotationally driven spindle 12 for receiving a wheel assembly, a column 14 carrying wheel service tools 15, such as bead break rollers on support arms 16, storage compartments 18, and user interface components 20. Additional components such as pneumatic or hydraulic pumps, and a motor for rotationally driving the spindle 12 supporting a wheel assembly may be contained within, or support by, the base 10. A control system (not shown) is operatively coupled to the various components of tire changing system to direct operation and carry out tire service procedures. Those of ordinary skill in the field of vehicle wheel service equipment will recognize that components utilized by tire changer systems 2 can be arranged in a variety of configurations and styles, such as by including a wheel lift (not shown) or side bead break shovel (not shown) without departing from the scope of the present disclosure.

To facilitate tire inflation, the tire changing system 2 includes an air supply line or hose 28 coupling an air chuck 26 directly or indirectly to a source of pressurized air, which may be an air pump and/or pressurized air tank carried by the wheel service system, or alternatively a connection to a remote pressurized air supply, such as a shop-wide air distribution system. A pressure gauge or sensor is operatively associated with the pneumatic pathway defined by the air chuck and air supply line to provide a measure of the pressure within the air supply line and a tire when the air chuck 26 is temporarily coupled to a valve stem of a wheel assembly secured to the driven spindle 12.

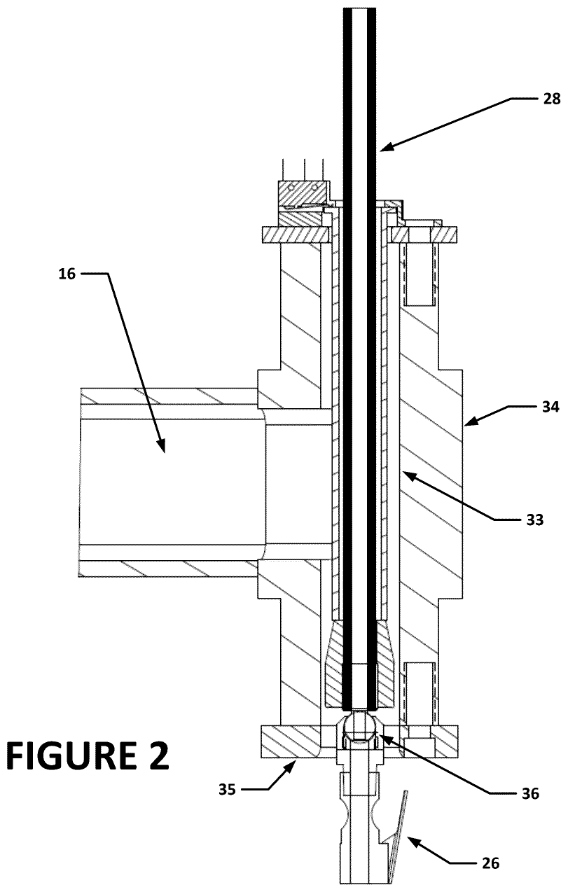

Preferably, the air supply line 28 to the air chuck 26 is routed to pass through a bore 33 within a housing 34 affixed to the tool support arm 16, as seen in FIG. 2 and as shown and described in PCT patent application publication No. WO 2025/064199 A1 to Meyer et al. The bore 33 is axially aligned with the driven spindle 12, such that the air chuck 26 is in general axial alignment with a vertical drive axis of the driven spindle 12 when retracted to the housing 34. During use, the air chuck and air hose are drawn from the bore 33 towards the spindle 12, enabling the air chuck to be coupled to the valve stem of a wheel secured to the spindle. To avoid twisting or kinking of the air supply line 28 by rotation of the wheel assembly on the driven spindle 12 during tire inflation or deflation, the air chuck 26 is secured to the air supply line 28 by a coupling 36, such as a ball swivel connection, permitting the air chuck 26 to rotate or swivel with respect to the air supply line 28. Exemplary systems and methods for inflating a tire mounted to a wheel rim on the wheel supporting spindle 12 using the air supply line 28 and air chuck 26 can be found in the aforementioned WO 2025/064199 A1 application.

In addition to enabling inflation of a tire on a wheel assembly secured to the driven spindle 12, the air chuck 26 and air supply line 28 can be utilized to facilitate deflation of the tire. In an embodiment of the present disclosure, the air supply line 28 is coupled to a vacuum pump, an air tank from which air has been evacuated, a venturi, or an open discharge port, such that the air supply line has an internal pressure equal to, or below, atmospheric air pressure. The connection to the vacuum pump, air tank, or discharge port from the air supply line 28 may be separated from the connection the source of pressurized air used for tire inflation by means of a diverting valve or selectable fluid pathway. Alternatively, the source of pressurized air may be controllable to provide variable pressure levels to the air supply line, i.e., to achieve air pressure levels which are both greater than atmospheric pressure (to be used during tire inflation), and which are equal to, or below atmospheric pressure (to be used during tire deflation).

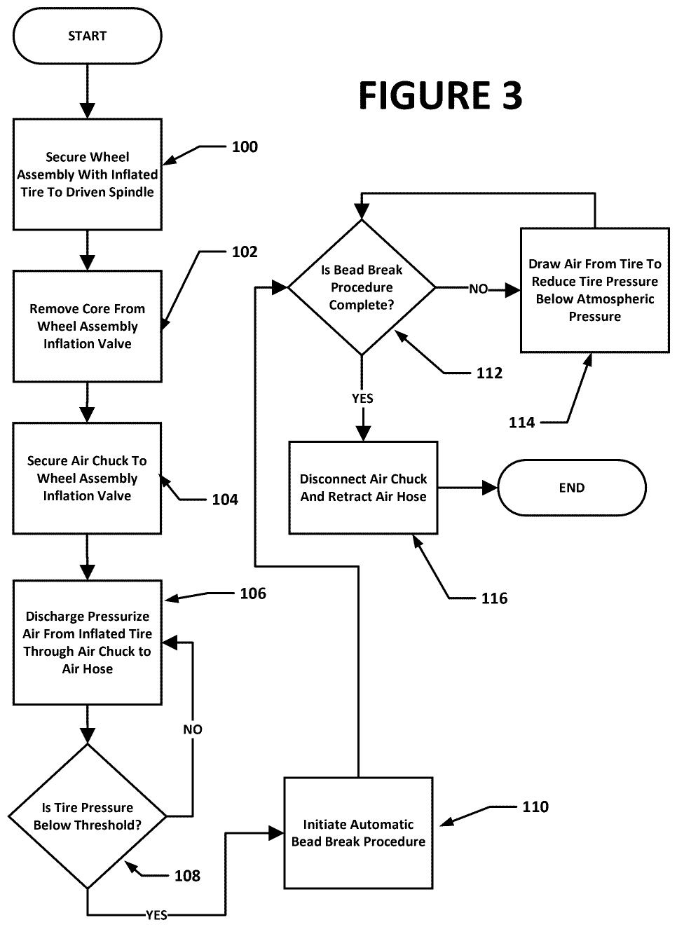

A tire deflation method of the present disclosure is illustrated by the flow chart of FIG. 3. Initially, an inflated tire on a wheel assembly is secured to the driven spindle 12 (Box 100). Once the wheel assembly is secured, the operator removes a core from the wheel assembly valve stem to begin tire deflation (Box 102). The air chuck 26 is then drawn from the retracted position, and connected to the valve stem (Box 104). Pressurized air within the tire is free to flow through the open valve stem and air chuck 26, discharging through the air supply line 28 to either a storage tank or a discharge port due to the pressure differential between the pressurized air contained within the tire and the internal pressure of the air supply line 28 being at or below atmospheric air pressure (Box 106). Those of ordinary skill in the art will recognize that the discharge flow rate of air from the pressurized tire through the air supply line 28 will vary in accordance with the nominal diameter of the air supply line, the length of the air supply line, and the pressure differential between the inflated tire and the air supply line 28.

In one embodiment the tire inflation pressure is monitored by a control system during deflation (Box 108), enabling the tire changing system 2 or other wheel service system, to automatically proceed with additional actions when the tire inflation pressure has dropped to a selected level. For example, the control system may be configured to automatically disconnect the air chuck 26 from the valve stem (if the air chuck is configured with an automatic disconnect) when the tire pressure is within a tolerance of atmospheric pressure. In yet another example as show in FIG. 3, the control system is configured to initiate a tire bead breaking procedure (Box 110) when the tire inflation pressure is within a tolerance of a predetermined value. The predetermined value for initiating a tire bead breaking procedure is preferably selected to be the highest inflation pressure at which tire bead breaking can be safely conducted by the tire changing system 2 without undue risk of wear or damage to the beak breaking tools 15. Initiating tire bead breaking automatically, even before the tire has fully deflated may allow the tire changing system 2 to complete a tire changing operation in a reduced amount of time without requiring operator action.

Until the bead break procedure is completed (Box 112), the control system is configured to continue to reduce the inflation pressure within the tire to below atmospheric pressure (Box 114), i.e., to create a partial vacuum within the tire in order to facilitate the tire bead breaking operations. By reducing the tire internal pressure to below atmospheric pressure, external atmospheric pressure may act to compress the tire sidewall surfaces, aiding in the tire bead breaking process. Reducing the amount of force required to be exerted by the tire bead breaking tools 15 may be particularly beneficial when performing a tire demount operation on large diameter tires having stiff sidewalls.

For embodiments in which the air chuck 26 is configured for automatic or controlled release from the valve stem, automatic detachment from the valve stem is triggered upon completion of the tire bead breaking procedure (Box 116), followed by retraction of the air hose 28 and air chuck 26 away from the wheel assembly to allow the demounted tire to be removed from the wheel rim and a replacement tire seated thereon.

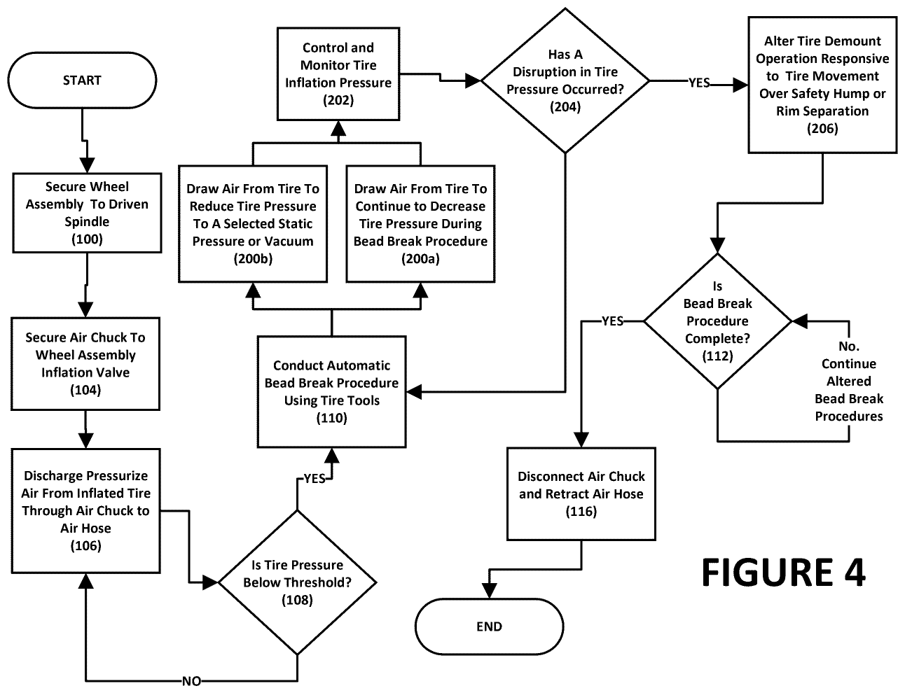

Turning to FIG. 4, a variation of the aforementioned method is illustrated wherein, during the bead breaking procedure (Box 110), a discharge of pressurized air from within the tire (Box 200a or Box 200b) is controlled and monitored (Box 202). In one option (Box 200a), as the pressurized air is discharged from the inflated tire through the air chuck and air hose, the tire inflation pressure is expected to decrease in a constant or uniform manner responsive to a pressure differential between the inflated tire and the internal pressure of the air supply line. Alternatively (Box 200b), the pressure within the tire of the wheel assembly may be held at a set level by selectively stopping the flow of air through the air hose, so as to maintain a static pressure level above atmospheric pressure, or a static vacuum below atmospheric pressure. With either option for establishing or lower the tire inflation pressures during the bead break procedure, an abrupt or sudden disruption in the monitored pressure level or discharge rate associated with the wheel assembly occurs when a tire bead transitions over the safety hump of the wheel rim, or is otherwise separated from the wheel rim, allowing a significant volume of pressurized air to escape (or atmospheric air to enter if the tire pressure is a vacuum below atmospheric pressure). Detecting such a change in the tire inflation pressure or rate of deflation (Box 204) is indicative of the change in condition of the wheel assembly, at which point the tire changing system 2 automatically alters the tire demount operation (Box 206), such as by increasing the rotational speed of the driven spindle, altering applied forces to the tire sidewall, or eliminating unnecessary actions in an attempt to reduce the time required to complete the bead break procedure. The altered bead breaking/tire demounting procedure is continued to completion. (Box 112). On tire changing systems having an air chuck 26 configured for automatic or controlled release from the valve stem, automatic detachment from the valve stem is triggered upon completion of the altered tire bead breaking procedure (Box 116), followed by retraction of the air hose 28 and air chuck 26 away from the wheel assembly to allow the demounted tire to be removed from the wheel rim and a replacement tire seated thereon.

Those of ordinary skill in the art will recognize that the tire deflation system of the present disclosure can be adapted for use, without departing from the scope of the invention, with a variety of automotive service equipment configured for controlled deflation of a wheel assembly tire, such as wheel balancing systems, wheel alignment inspection systems, ADAS inspection systems, tire inflation stations, inflation cages, and vehicle lift systems.

The present disclosure can be embodied in-part in the form of computer-implemented processes and apparatuses for practicing those processes. The present disclosure can also be embodied in-part in the form of computer program code containing instructions embodied in tangible media, or another computer readable non-transitory storage medium, wherein, when the computer program code is loaded into, and executed by, an electronic device such as a computer, micro-processor or logic circuit, the device becomes an apparatus for practicing the present disclosure.

The present disclosure can also be embodied in-part in the form of computer program code, for example, whether stored in a non-transitory storage medium, loaded into and/or executed by a computer, or transmitted over some transmission medium, wherein, when the computer program code is loaded into and executed by a computer, the computer becomes an apparatus for practicing the present disclosure. When implemented in a general-purpose microprocessor, the computer program code segments configure the microprocessor to create specific logic circuits.

As various changes could be made in the above constructions without departing from the scope of the disclosure, it is intended that all matter contained in the above description or shown in the accompanying drawings shall be interpreted as illustrative and not in a limiting sense.

1. A wheel assembly service system supporting a wheel assembly consisting of a rim and tire mounted there on, comprising:
at least one air chuck configured to temporarily engage a valve stem of a wheel assembly, said air chuck configured to receive a flow of air from said valve stem, and wherein said air chuck is in fluid communication with an air hose having an internal air pressure initially below atmospheric pressure; and
wherein said air hose is in further communication with a means for discharging pressurized air received from said tire through said air chuck engaged with said valve stem.

2. The wheel assembly service system of claim 1 wherein said means for discharging includes at least one of a discharge port, a venturi, a vacuum pump, or a low pressure chamber.

3. The wheel assembly service system of claim 1 further including a control system, said control system operatively coupled to at least one sensor configured to generate a signal representative of an inflation pressure within said tire; and
wherein said control system is configured with software instructions to execute one or more tire service operations responsive to said inflation pressure within said tire.

4. The wheel assembly service system of claim 3 wherein said control system is configured with software instructions to initiate a tire bead break procedure by actuating one or more tire bead breaking tools in response to said inflation pressure being equal to or less than a selected value.

5. The wheel assembly service system of claim 3 wherein said control system is configured with software instructions to initiate a tire bead break procedure by actuating one or more tire bead breaking tools in response to said inflation pressure being less than atmospheric pressure.

6. The wheel assembly service system of claim 1 wherein said service system is one of a tire changing machine, a wheel balancer, or a tire inflation cage.

7. A method for operating a vehicle wheel service system, comprising:
securing a wheel assembly in a stable position, said wheel assembly including a wheel rim, and a tire mounted on said wheel rim, and a valve stem in said wheel rim which is in fluid communication with a volume of pressurized air contained within said wheel assembly;
coupling an air chuck to said valve stem, said air chuck providing a fluid coupling between said valve stem and an air hose for transfer of pressurized air; and
automatically deflating said tire by discharging said pressurized air from said wheel assembly into a volume having an air pressure less than atmospheric pressure, said pressurized air discharged through said air hose via said valve stem and air chuck.

8. The method of claim 7 further including monitoring a level of air pressure within said wheel assembly during deflation; and
automatically actuating one or more tire manipulating tools to initiate a tire bead breaking procedure to separate said tire from said wheel rim in response to said air pressure within said wheel assembly decreasing below a threshold.

9. The method of claim 8 wherein deflation of said tire is continued during said bead breaking procedure.

10. The method of claim 8 wherein said threshold is set to atmospheric pressure.

11. The method of claim 9 wherein said air pressure within said wheel assembly is reduced to a level which is below atmospheric pressure during said tire bead breaking procedure.

12. A method for operating a tire changing machine having a rotationally driven spindle for supporting a wheel assembly, a set of actuated tire manipulating tools, and a control system configured to control operation of said drive spindle and said set of tools to demount a tire from a rim of said wheel assembly, comprising:
securing said wheel assembly to said rotationally driven spindle;
coupling an air chuck to a valve stem of said wheel assembly, said air chuck providing a fluid coupling between said valve stem and an air hose for transfer of pressurized air from a volume contained within said wheel assembly;
rotationally driving said spindle to rotate said wheel assembly about an axis of rotation; and
automatically deflating said tire by discharging said pressurized air from said wheel assembly through said air hose via said valve stem and air chuck during rotation of said wheel assembly about said axis of rotation.

13. The method of claim 12 wherein said pressurized air is discharged to a volume having an air pressure maintained below atmospheric air pressure.

14. A method for operating a vehicle wheel service system having a rotationally driven spindle supporting a wheel assembly, one or more actuated tire manipulating tools, and a control system configured to control operation of said driven spindle and said one or more tools to demount a tire from a rim of said wheel assembly, comprising:
securing said wheel assembly to said rotationally driven spindle;
coupling an air chuck to a valve stem of said wheel assembly in fluid communication with a volume of pressurized air contained within said wheel assembly, said air chuck providing a fluid coupling between said valve stem and an air hose for transfer of pressurized air;
deflating said tire by discharging said pressurized air from said wheel assembly through said air hose via said valve stem and air chuck;
monitoring the level of air pressure within said tire during deflation; and
automatically actuating said driven spindle and/or said one or more tire manipulating tools to initiate a bead breaking procedure to separate said tire from said rim in response to said air pressure within said tire decreasing below a threshold.

15. The method of claim 14 wherein said pressurized air is discharged to a volume having an air pressure maintained below atmospheric air pressure.

16. The method of claim 14 wherein said bead breaking procedure includes monitoring said level of air pressure within said tire; and
wherein said bead breaking procedure is altered responsive to a disruption in said monitored air pressure corresponding to a displacement of a tire sidewall surface over a safety hump of said rim, or a separation of a tire bead from said rim.

17. The method of claim 16 wherein said discharge of pressurized air through said air hose via said valve stem and air chuck is stopped during said bead breaking procedure to maintain a static pressure below said threshold within said wheel assembly; and
wherein said bead breaking procedure is altered responsive to a change in said static pressure indicative of a displacement of a tire sidewall surface over a safety hump of said rim, or a separation of a tire bead from said rim.

18. The method of claim 16 wherein said discharge of pressurized air through said air hose via said valve stem and air chuck is continued during said bead breaking procedure to establish a static vacuum pressure below said threshold within said wheel assembly; and
wherein said bead breaking procedure is altered responsive to a change in said static vacuum pressure indicative of a displacement of a tire sidewall surface over a safety hump of said rim, or a separation of a tire bead from said rim.

19. The method of claim 16 wherein a rate of said discharge of pressurized air through said air hose via said valve stem and air chuck is monitored during said bead breaking procedure; and
wherein said bead breaking procedure is altered responsive to a change in said rate of said deflation indicative of a displacement of a tire sidewall surface over a safety hump of said rim, or a separation of a tire bead from said rim.
